(19) United States
(12) Patent Application Publication
(10) Pub. No.: US 2011/0017144 A1
(43) Pub. Date: Jan. 27, 2011

(54) Marine Nursery Habitat

(76) Inventor: Michael D. Calinski, Captiva Island, FL (US)

Correspondence Address: ST. ONGE STEWARD JOHNSTON & REENS, LLC, 986 BEDFORD STREET, STAMFORD, CT, 06905-5619, US

(21) Appl. No.: 12/841,694

(22) Filed: Jul. 22, 2010

Related U.S. Application Data
(60) Provisional application No. 61/227,482, filed on Jul. 22, 2009.

(51) Int. Cl. A01K 61/00

(52) U.S. Cl. 119/200

(57) ABSTRACT

A multi-tier marine nursery habitat, comprised of a plurality of fiberglass or other non-degrading tier panels, secured in vertically spaced relation by vertical tie rod elements passing through spacer elements of plastic (inserted “plastic, deleted “PVC”) pipe sections, with flotation elements attached at the top. The surfaces of the panels are covered with crushed shells. Sections of polypropylene or other non-degrading rope extend vertically through the assembled tier panels in a predetermined closely spaced-apart relation to provide simulated prop roots providing high surface area for attachment of marine organisms. The habitat is comprised of inexpensive components and is particularly suitable for manual assembly at low cost with relatively unskilled labor.

### CROSS-REFERENCE TO RELATED APPLICATIONS

The present application claims the benefit under 35 U.S.C. §119(e) of the U.S. Provisional Patent Application Ser. No. 61/227,482, filed on Jun. 22, 2009, the content of which is incorporated herein by reference. This application is also related to my co-pending application Ser. No. 12/433,132, filed Apr. 30, 2009, and to my prior U.S. Pat. No. 6,089,191, granted Jul. 18, 2002, the contents of both of which are incorporated herein by reference.

### FIELD OF THE INVENTION

The invention relates to marine nursery habitat structures and more particularly to such structures that are functionally superior and also economical and suitable for easy manual assembly.

### BACKGROUND OF THE INVENTION

Marine nursery habitat structures are well known in general and can provide an environment that encourages the growth of a wide variety of marine organisms. Such structures not only encourage the growth of various early juvenile crabs, lobsters, and fish, but also a wide variety of filter feeding organisms, such as oysters, sea squirts, mussels and sponges. The filter feeders serve an important function of naturally filtering and cleaning a variety of pollutants from the waters. Accordingly, effective engineered marine habitat structures are desirably deployed in and around marinas and man-made canal systems where natural nursery habitat and the filter-feeding community it supports has been destroyed by development, for example. Specifically, they can be placed preferably under docks, and in areas free of boat traffic to improve water quality while simultaneously providing vital nursery areas for promoting the growth of crabs, lobsters, various varieties of fish, etc., during their early juvenile stages.

### SUMMARY OF THE INVENTION

The present invention is directed to the design and construction of marine nursery habitat structures which are highly effective for the intended purposes of encouraging the growth of a variety of desirable marine organisms and which, at the same time, are of a simplified structural character, suitable for inexpensive manufacture using in large part relatively unskilled manual labor. The structure of the invention is capable of assembly in a variety of configurations, to provide optimal conditions for the growth of targeted organisms. The habitats thus may easily be designed and constructed to serve as nurseries, to attract and grow particular types of organisms deemed desirable to a given area, whether for the propagation of desired food species or for the encouragement of filter feeding species for water quality improvement, or both.

The nursery habitat structure of the invention is comprised of a plurality of generally flat panels, vertically spaced apart and forming multiple tiers. The tier panels are coated on their top and bottom surfaces with crushed fossil shells. One or more floatation elements are provided to support the tier panels a desired distance below the water surface. Importantly, the several tier panels are provided with a densely arranged plurality of vertically aligned guide openings for the reception of lengths of rope. The ropes are “laced” through the structure, extending vertically in one direction between top and bottom tiers, then laterally to an adjacent series of openings, and then vertically in the opposite direction, etc., through the various vertically aligned guide openings. The lacing ropes provide a densely grouped arrangement of vertical rope sections between tier panels, which serve as simulated mangrove prop-roots and provide large and attractive surface areas for marine organisms to attach to the habitat structure.

For a more complete understanding of the above and other features and advantages of the invention, reference should be made to the following detailed description of preferred embodiments thereof and to the accompanying drawings.

### BRIEF DESCRIPTION OF THE DRAWINGS

FIG. 1 is a perspective view of the habitat, with flotation elements attached.

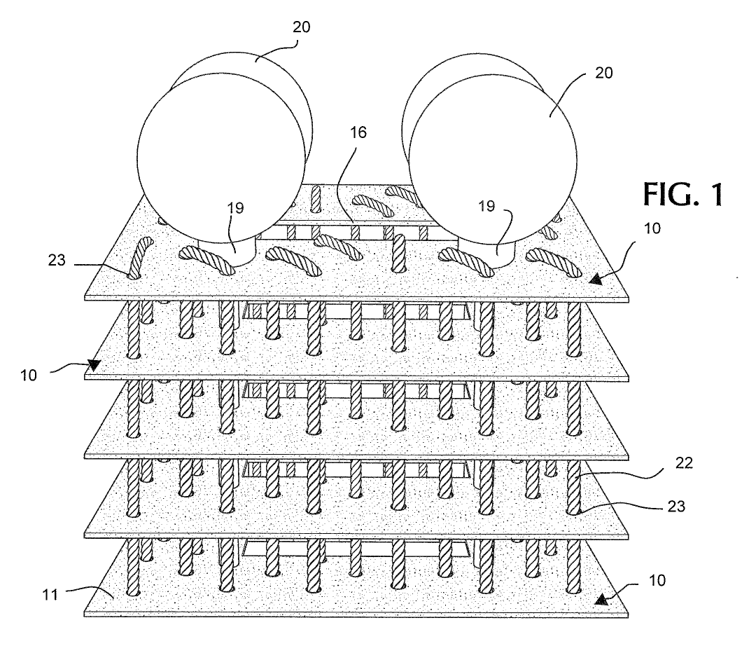

FIG. 2 is a perspective view of the habitat without flotation elements.

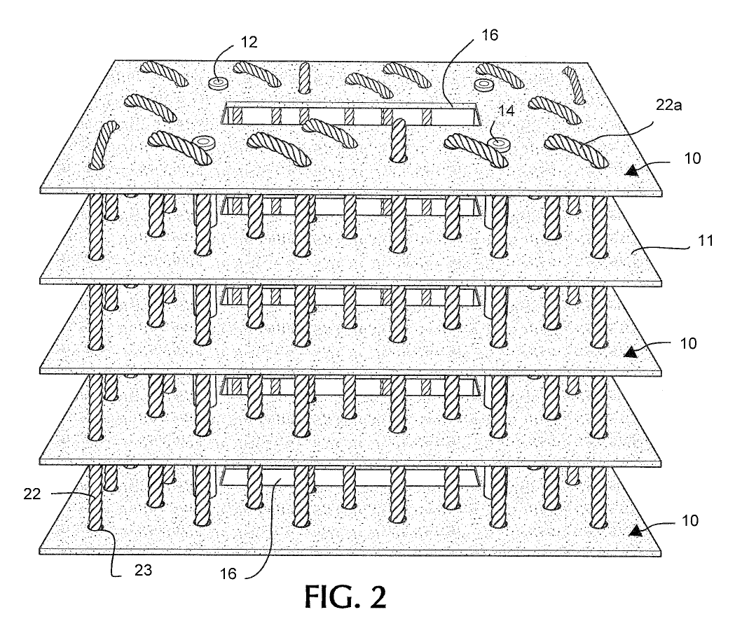

FIG. 3 is a bottom view of the habitat, illustrating a preferred arrangement of lacing rope forming simulated prop roots.

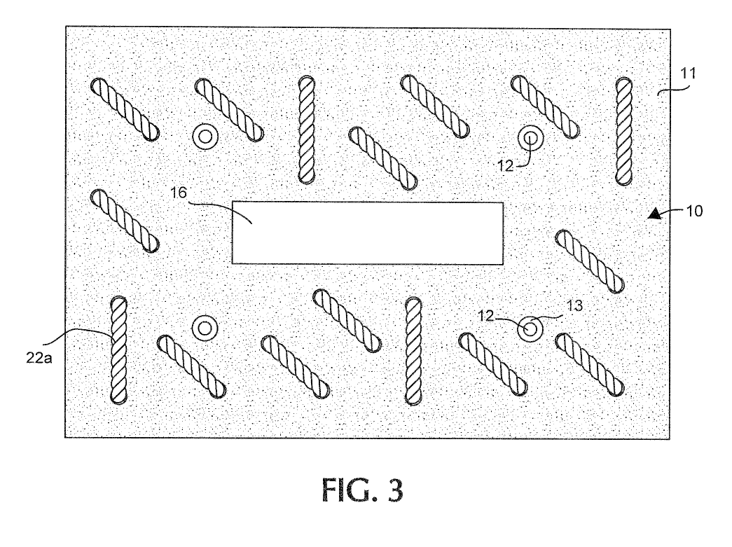

FIG. 4 is a fragmentary cross sectional view of the structure of FIG. 1, illustrating a preferred arrangement for joining and supporting a plurality of tier panels according to the invention.

FIG. 5 is a perspective view of an alternative form of floatation device for supporting the marine habitat of the invention.

### DETAILED DESCRIPTION OF THE INVENTION

The present invention is directed to an inexpensive nursery habitat structure which, while being functionally advantageous, lends itself well to manual assembly. The illustrated structure comprises five tier panels 10, each formed of a relatively stiff, multi-ply fiberglass mat of approximately 36 inches by 24 inches in size, coated on both sides with an adhesively bonded layer 11 of crushed fossil shells. In a preferred embodiment, a three ply panel of 1.5 oz fiberglass matting is suitable for the tier panels. The crushed fossil shells provide a preferred calcium carbonate substrate. Experience has shown that the larvae of filter-feeding oysters, mussels, sea squirts and sponge prefer the crushed shells to the plain fiberglass mat. The shells also provide a better holding surface than the fiberglass, which helps prevent the organisms from being dislodged during rough weather. The shell substrate also provides a good medium for small detritivores, such as amphipods and worms to hide in. The latter organisms are desirable in a habitat because they consume waste from the filter feeder organisms, and also serve as necessary prey for developing fish and crustaceans.

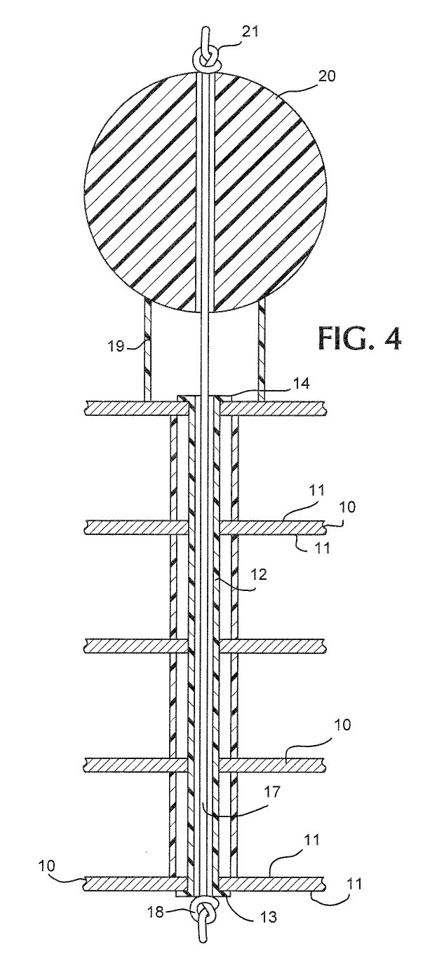

In the illustrated embodiment, five tier panels 10 are preferred. However, the specific number is not critical, and there may be more or fewer panels depending on available space, water depth, and other factors. The several tier panels are secured together by a plurality (four in the illustrated arrangement) of tie rod elements 12 (FIG. 4) advantageously formed of PVC pipe or other non-degrading pipe of, for example ½ inch size. The tie rod elements 12 are flared out below the bottom tier panel and above the top tier panel to form bottom and top retaining flanges 13, 14. Spacer elements 15, which may be short sections of 1.5 inch PVC or other non-degrading pipe, surround the tie rod elements 12 between each of the tier panels 10 and serve to position the panels in a desired, spaced apart, parallel relation as shown.

In the illustrated embodiment, the spacer elements have a length of about five inches. However, the spacer length may vary between a minimum of about three inches and a maximum of about eight inches, depending upon the particular species of marine life sought to be attracted and developed. For example, juvenile stone crabs and lobsters prefer a tight spacing, such as three inches, while certain fish species, such as snapper and snook, prefer a spacing of about eight inches. If the spacing exceeds about eight inches, predators can attack either the developing fish and crustaceans, or the mussels and oysters, and it is important to support and protect these species for their filtering functions.

In the illustrated and preferred embodiment there are four vertically aligned groups of tie rod elements 12 and spacers 15. A section of floatation rope 17 extends internally through each tie rod element 12 and is knotted off at 18, underneath the lowest tier panel. The floatation ropes extend upward, above the upper tier panel, through a cylindrical section 19 of PVC or other non-degrading pipe and through a floatation ball 20 positioned on the pipe section 19. The ropes 17 are knotted off at 21, above the floatation balls 20 to secure the floatation balls to the habitat structure. The floatation balls are formed of a non-toxic, non-leaching HDPE plastic material. Four floatation balls 20 of about 12 inches in diameter provide ample floatation for a habitat of the example dimensions indicated herein. By providing such flotation the nursery habitat is largely protected from bottom dwelling predators that could attack either young fish and crustaceans or the filter feeders.

When the habitats are placed in the water, they will sink to a level at which the flotation balls 20 are partly submerged, with all tier panels well below the water surface. The habitats are suitably anchored or tethered underneath docks, for example, where they can rise and fall with the tides but otherwise remain in the same location.

Desirably, each of the tier panels 10 is formed with a central opening 16 of approximately 6 inch by 18 inch size, to provide for good circulation of water in the central regions of the tier panels. Without this opening experience has shown that the center areas of the habitats would suffocate and die.

In accordance with the invention, one or more sections 22 of polypropylene or other non-degrading lacing rope are passed vertically through aligned guide openings 23 in the tier panels 10, first in one direction, then horizontally (22a) across the top or bottom tier panel to an adjacent series of aligned openings, and then vertically in the other direction. The rope sections 22 are spaced relatively close together, for example around 5-6 inches apart. Although the lacing rope sections 22 serve a function in securing the structure in its assembled relation, a more important function of the lacing ropes is to provide a large number of artificial prop-roots, simulating the prop roots of mangrove trees and forming multiple attachment areas for marine life. One inch or ¾ inch polypropylene or other non-degrading rope is suitable for this purpose, although smaller diameter rope can be used depending on the application; for example in nutrient rich water where mussels are the preferred filter feeders, ⅜ or ½ in rope may be used.

In the illustrated embodiment of the invention, there is a total of 32 vertical sections 22 of lacing rope, which can be arranged as a single rope length, threaded through the tier panels 10 or, more typically a plurality of rope lengths threaded through some of the guide openings 23 and tied off as appropriate. This provides a densely packed arrangement of simulated prop-roots, providing numerous locations for attachment of marine organisms as well as secure hiding places against predators.

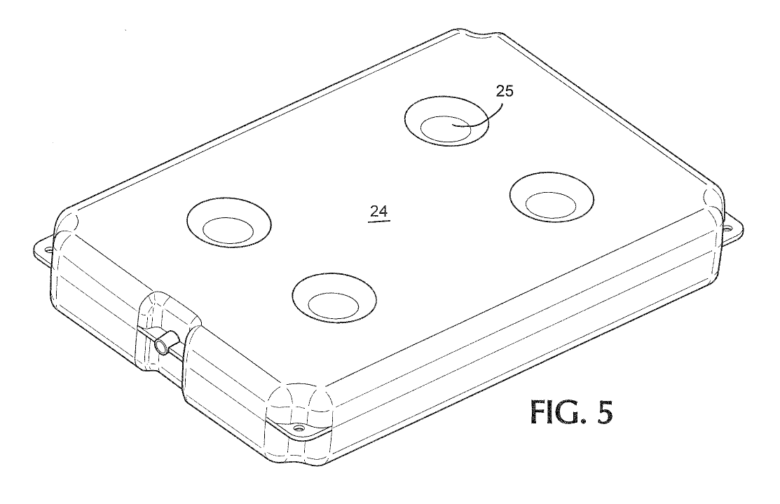

An alternative form of floatation, in place of the balls 20, is shown in FIG. 5. A single float 24 of rectangular configuration is arranged with four openings 25 spaced and positioned to correspond with the positions of the tie rod elements 11 of the main structure. In the alternative arrangement, the floatation ropes 17 are passed through the openings 25 and tied off or otherwise secured so that the float is attached to the habitat structure. As in the case of the floatation balls 20, the rectangular float 24 is formed of HDPE, which is non-toxic and non-leaching and, for practical purposes, largely indestructible.

The described habitat structures, with extensive attachment surfaces provided by the coated tier panels, the polypropylene lacing ropes and the various PVC or other non-degrading pipe spacers, achieves a very favorable surface area to volume (SAV) ratio of about 6.4 to 1. Alternately, this SAV ratio can be changed by changing the length of the spacers to accommodate site-specific species as described above.

The panels and “prop roots” of the habitats form attractive surfaces for juvenile oysters, muscles, sea squirts and other filter feeders to attach themselves and grow. These in turn can attract juvenile lobsters and various types of juvenile crabs, as well as various forms of small food fish, which grow in relative safety and then typically leave the habitat when they become too large for the space provided. Experience has shown that the filter feeder elements occupying the habitats can filter and clean very large volumes of water on a continuing basis and thus provide a significant improvement in the ecology of the shoreline waters, as well as providing for excellent breeding and development of certain desirable forms of marine life. In a marine habitat of the type and size described herein, filter-feeding elements can effective filter about 10,000 or more gallons of water each day, making a very significant and favorable impact on the water quality where such habitats are deployed.

It should be understood, or course, that the specific embodiments of the invention herein described are intended to be representative of the invention but not limiting. Accordingly, reference should be made to the following appended claims in determining the full scope of the invention.

What is claimed is:

1. A marine nursery habitat comprising
(a) a plurality of generally flat horizontally disposed tier panels of fiberglass or other non-degrading material construction, each having a central opening therein to accommodate the flow of water,
(b) said tier panels being coated on top and bottom surfaces thereof with crushed fossil shells,
(c) said tier panels being arranged in a vertically spaced assembly thereof and having a first plurality of vertically aligned openings for the reception of a plurality of vertical tie rod elements extending from a bottom tier panel to a top tier panel of the assembly and secured to said top and bottom tier panels,
(d) spacer elements positioned between each of the tier panels in closely adjacent relation to each of said tie rod elements, whereby said tie rod elements and said spacer elements secure said plurality of tier panels in a relatively rigid, spaced apart, parallel relation,
(e) said tier panels each having a large plurality of guide openings therein arranged such that guide openings in each panel are vertically aligned with corresponding openings in panels above and below,
(f) one or more sections of lacing rope passing through said guide openings, and extending vertically between the bottom and top tier panels to form, together with other sections of lacing ropes, a densely packed structure of simulated prop roots, and
(g) one or more floatation elements secured above the top tier panel for buoyantly supporting said habitat in water with the top tier panel below a surface of said water.

2. A marine habitat according to claim 1, wherein
(a) said spacer elements comprise sections of plastic pipe positioned in surrounding relation to said tie rod elements, and
(b) the spacer elements between each adjacent pair of tier panels being of equal length, and
(c) said spacer elements having a length of from about three inches to about eight inches.

3. A marine habitat according to claim 1, wherein
(a) said tie rod elements comprise lengths of plastic pipe of a diameter smaller than a diameter of said spacer elements,
(b) said tie rod elements being flared outward immediately below the bottom tier panel and immediately above the top tier panel to secure the plurality of said panels in a rigid structure, with the tier panels separated by said spacer elements.

4. A marine habitat according to claim 3, wherein
(a) floatation ropes are extended vertically through said tie rod elements and are secured at lower ends of said elements, and
(b) upper ends of said floatation ropes are secured to said one or more floatation elements.

5. A marine habitat according to claim 4, wherein
(a) a separate floatation element is provided for each floatation rope, and
(a) each of said floatation ropes is connected at the upper end thereof with one of said floatation elements.

6. A marine habitat according to claim 4, wherein
(a) said one or more floatation elements comprises a single floatation element, and
(b) each of said floatation ropes is connected at the upper end thereof with said single floatation element.

7. A marine habitat according to claim 1, wherein
(a) said tier panels are of generally rectangular configuration, and
(b) said central openings therein comprise at least about one-eighth of the area of the panels.

8. A marine habitat according to claim 7, wherein
(a) said sections of lacing rope are separated by a distance of approximately 5 to 6 inches from each other to form said densely packed structure of simulated prop roots.

9. A marine habitat according to claim 8, wherein
(a) said tier panels have a length of about 36 inches and a width of about 24 inches, and
(b) said structure includes approximately 32 vertically extending sections of said lacing ropes.

10. A marine habitat according to claim 9, wherein
(a) at least some of said lacing ropes extend vertically in one direction between top and bottom tier panels, then laterally to an adjacent series of guide openings, and then vertically in the opposite direction between top and bottom tier panels.
